(19) United States
(12) Patent Application Publication
(10) Pub. No.: US 2014/0338761 A1
(43) Pub. Date: Nov. 20, 2014

(54) AUTOMATIC VALVE WITH INTERCHANGEABLE SEAT PLATE

(71) Applicant: NUOVO PIGNONE S.P.A., Florence (IT)

(72) Inventors: Alberto Babbini, Firenze (IT); Riccardo Bagagli, Firenze (IT); Leonardo Tognarelli, Firenze (IT); Guido Pratelli, Firenze (IT)

(73) Assignee: NUOVO PIGNONE S.P.A., Florence (IT)

(21) Appl. No.: 14/364,268

(22) PCT Filed: Dec. 11, 2012
(86) PCT No.: PCT/EP2012/075060

§ 371 Date: Jun. 10, 2014

(30) Foreign Application Priority Data
Dec. 12, 2011 (IT) FI2011A000268

(51) Int. Cl. F16K 25/00; F16K 15/08

(52) U.S. Cl. CPC F16K 25/00; F16K 15/08
USPC 137/382

(57) ABSTRACT

An automatic valve comprising a valve seat with first gas flow passages extending there through, and a valve guard having second gas flow passages extending there through. Sealing rings are arranged between the valve guard and the valve seat. A removable seat plate is removably connected to the valve seat and is provided with apertures matching with the first gas flow passages of the valve seat. The sealing rings are resiliently biased by resilient members against the removable seat plate to close the valve. The seat plate and the rings are made of non-metallic material.

### FIELD OF THE INVENTION

The present disclosure relates to automatic valves, such as ring or annular valves. Some embodiments of the subject matter disclosed herein relate specifically to automatic ring or annular valves for reciprocating compressors.

### DESCRIPTION OF THE RELATED ART

Automatic valves are commonly used for example in reciprocating compressors. Automatic valves are arranged on both the suction side as well as the discharge side of the compressor, to automatically open and close the suction port and discharge port of the compressor under the control of the pressure inside the compressor cylinder.

An exemplary embodiment of an automatic ring valve of the prior art is illustrated in FIG. 1. The automatic ring valve 1 comprises a valve seat 2 and a valve guard 3. The valve seat is provided with circumferentially arranged gas flow passages 4 extending through the valve seat 2. The valve guard 3 is in tum provided with gas flow passages 5. A central screw 6 connects the valve seat 2 and the valve guard 3 to one another leaving a space 7 there between. A plurality of concentrically arranged sealing rings 8 are provided between the valve seat 2 and the guard valve 3. Each sealing ring 8 is arranged along a set of corresponding annularly arranged gas flow passages 4 of the valve seat 2. A plurality of compression springs 9 is provided for each sealing ring 8 to bias the sealing ring in a closed position, wherein the sealing ring 8 closes the respective set of gas passages 4 by sealingly contacting corresponding sealing surfaces 4A of the gas flow passages 4. The compression springs 9 are housed in respective spring pockets 10 provided in the valve guard 3.

Differential pressure across the valve 1 causes automatic opening and closing of the valve. FIG. 2 illustrates the head 11 of a reciprocating compressor using four automatic ring valves 1 arranged on the suction ports and discharge ports of the compressor and designated 1A, 1B, 1C, 1D.

More in detail, the compressor head 11 defines a compressor cylinder 13 wherein a piston 14 is reciprocatingly movable. A rod 15 of the piston 14 is connected to a crank (not shown), which reciprocatingly moves the piston 14 according to double arrow fl4. The piston 14 divides the cylinder 13 into two separate compression chambers 13A, 13B.

The compressor head 11 is provided with a first suction port 17 in fluid communication with the first compression chamber 13A through a first automatic ring valve 1A. A second suction port 19 is in fluid communication with the second compression chamber 13B through a second automatic ring valve 1B. A first discharge port 21 is in fluid communication with the first compression chamber 13A through a third automatic ring valve 1C and a second discharge port 23 is in fluid communication with the second compression chamber 13B through a fourth automatic ring valve 1D.

The reciprocating motion of the piston 14 causes selectively suction of the gas in the first compression chamber 13A and discharge of compressed gas from the second compression chamber 13B and vice versa. The automatic ring valves 1A, 1B, 1C and 1D selectively open when the pressure in the first gas flow passages 4 exceeds the resilient force of the springs 9.

The crank shaft of reciprocating compressors can rotate at a rotary speed in the range of for example 100-1200 rpm and typically between 200 and 1000 rpm. The sealing rings 8 are therefore subject to repeated opening and closing strokes at high speed. They are commonly made of composite material, such as fiber-reinforced synthetic resin to reduce the mass thereof and thus the inertia. The valve seat 2 and the valve guard 3 are typically made of metal.

Both the sealing rings 8 and the valve seat 2 are subject to wear due to fatigue stress. The automatic ring valves are therefore subject to maintenance. The sealing rings 8 are replaced while the valve seat requires reshaping by machining of the annular sealing surfaces 4A. This operation requires removing the automatic ring valve from the compressor and is time consuming. The compressor is therefore subject to long shut-down or replacement valves must be available to replace those, which require machining and reshaping of the valve seat. Similar drawbacks arise in automatic valves comprising a movable sealing element different from concentrically arranged sealing rings, for example a movable sealing plate.

Automatic valves are subject to thermal stresses due to the heat generated by friction and gas compression. The various components of the valve are therefore subject to thermal expansion. Use of different materials for the manufacturing of the valve seat and the sealing rings causes differential thermal expansions, due to different thermal expansion coefficients of the material used. This can lead to inefficient sealing of the gas flow passages and consequent gas leakages, resulting in a reduction of the compressor efficiency, unless planar sealing surfaces are used. The latter, on the other hand, are not entirely satisfactory from the point of view of an efficient sealing action. Similar drawbacks arise if a movable sealing plate is used, e.g. provided with annular projections co-acting with annular seats on the valve seat.

Opening and closing of the sealing rings 8, or similarly of a movable sealing plate, generates repeated dynamic stresses on the structure of the valve due to the impact of the sealing rings 8 against the valve seat 2 during the closure.

It would therefore be desirable to develop an improved differential pressure valve, and specifically an automatic ring valve for a reciprocating compressor or similar machinery, that will at least alleviate at least one of the above mentioned problems and drawbacks of the prior art ring valves.

### SUMMARY OF THE INVENTION

According to some embodiments of the subject matter disclosed herein, an automatic valve is provided, wherein one or more movable sealing elements (e.g. a plurality of concentrically arranged sealing rings) and a removable seat plate are provided, both of which are made of a non-metallic material, more particularly having a similar or substantially the same thermal expansion coefficient. The advantages of using movable non-metallic sealing rings or other movable sealing elements is thus maintained, but at the same time the drawbacks caused by differential thermal expansion, such as gas leakage, and reduction of the compressor efficiency derived therefrom, are at least partly alleviated, or entirely removed. Using a removable and thus interchangeable seat plate makes maintenance of the valve easier, removing the need for re-machining worn valve seats. The worn, broken or deformed seat plate can be simply removed and replaced in a short time, without requiring long machine down-time for maintenance intervention.

Thus, according to one embodiment, an automatic valve is provided, comprising: a valve seat having first gas flow passages extending there through; a valve guard having second gas flow passages extending there through; at least one movable sealing element arranged between the valve guard and the valve seat; a seat plate removably connected to the valve seat, and arranged between the valve seat and the movable sealing element, provided with apertures matching the first gas flow passages. The movable sealing element is resiliently biased by spring elements against the removable seat plate to close the first gas flow passages; and the seat plate as well as the movable sealing element or elements are made of non-metallic composite material.

As noted above, the movable sealing elements can be actually formed by annular, concentrically arranged rings forming sealing surfaces co-acting with the removable seat plate. The rings can be connected to one another to form a single structure. Alternatively, the rings can be separate from one another and independently biased towards the seat plate by respective resilient members, such as compression springs arranged according to concentrically arranged annular alignments, a plurality of springs being provided to bias each ring independently of the adjacent rings. In that case the movable sealing element will be formed by concentrically arranged sealing rings, separate from one another.

According to some embodiments the seat plate and the movable sealing element or elements are made of composite material. The composite material of the two components can be the same. In some embodiments, a different composite material can be used for the movable sealing element or elements and the seat plate respectively, e.g. based on design considerations. In particular embodiments, even if different composite materials are used for the seat plate and the movable sealing element or elements respectively, said composite materials have substantially the same thermal expansion coefficient.

The use of a seat plate and movable sealing element(s) made of non-metallic material having similar or substantially the same thermal expansion coefficients makes it possible to use non-planar sealing surfaces, which provide efficient sealing action and lower pressure losses. The two components will, in fact, be subject to similar or substantially the same radial expansions when subject to temperature increase, such that they will maintain the reciprocal shape and dimensional matching conditions, thus maintaining the sealing efficiency.

In some embodiments, the composite material forming the seat plate and the movable sealing element(s) can be a synthetic resin matrix, more particularly a matrix of thermoplastic resin, containing reinforcement fibers and/or different type of fillers. These include but are not limited to glass fibers and carbon fibers. The movable sealing element(s) can be provided with a plurality of first sealing surfaces, co-acting in sealing contact with second sealing surfaces on the seat plate, said second sealing surfaces extending along the apertures in said seat plate. More particularly the first sealing surfaces and said second sealing surfaces are non-planar.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein

FIG. 1 illustrates a cross section according to a longitudinal plane of an automatic ring valve of the prior art;

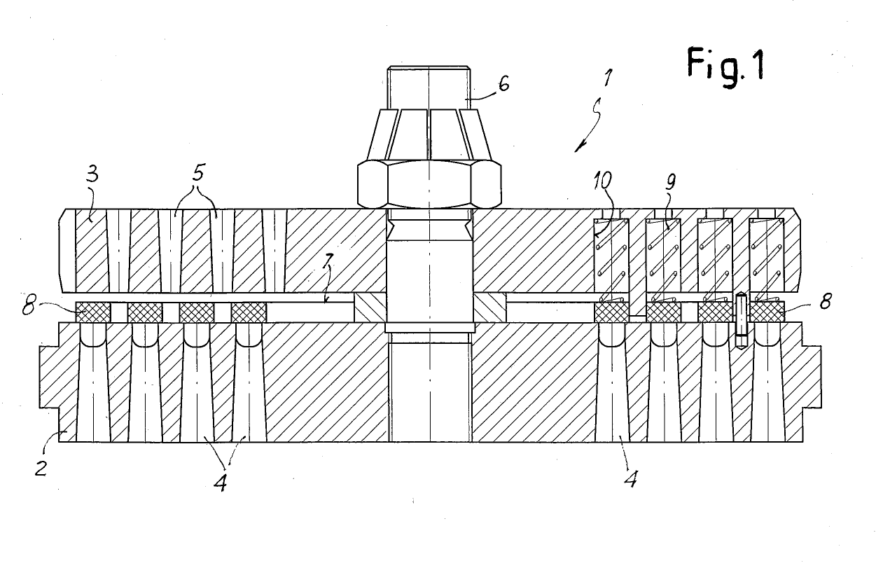

FIG. 2 illustrates longitudinal cross section of the head of a reciprocating compressor using automatic ring valves;

FIG. 3 illustrates a perspective and cross sectional view of a valve according to the present disclosure;

FIG. 3A illustrates an enlargement of the detail A of FIG. 3;

FIG. 4 illustrates the valve of FIG. 3 in an exploded view;

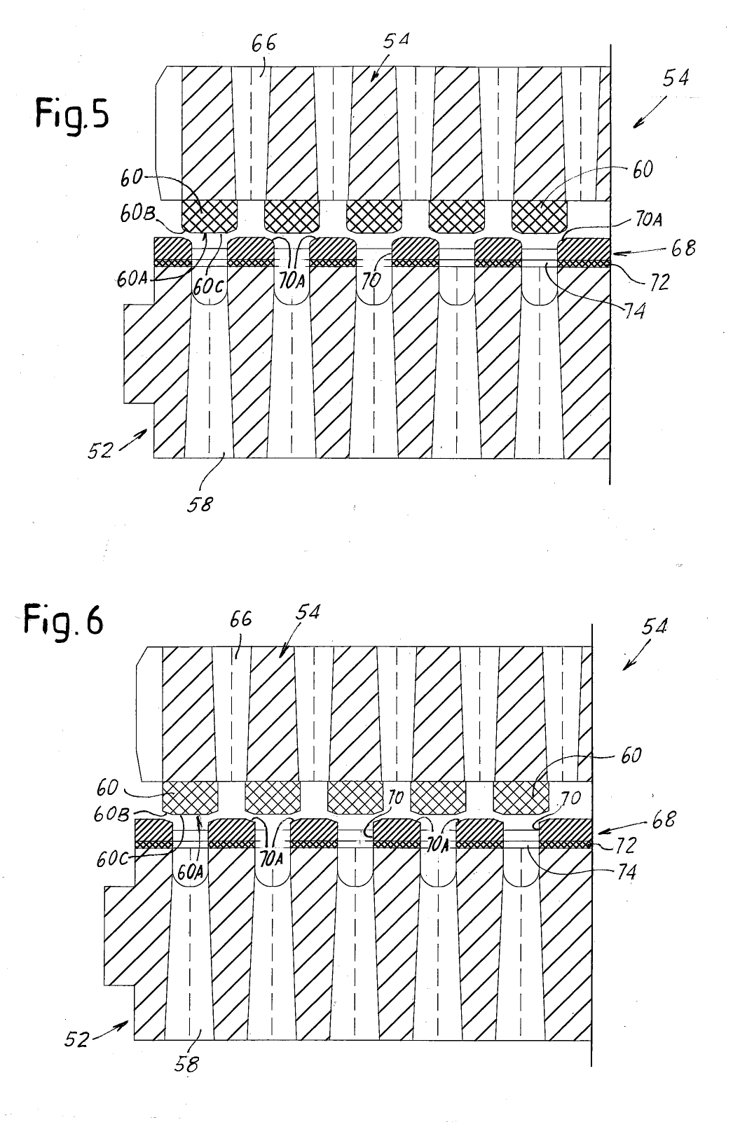

FIGS. 5, 6, and 7 illustrate enlarged partial cross sectional view of the valve showing different embodiments of the seat plate and of the sealing rings.

### DETAILED DESCRIPTION OF EMBODIMENTS OF THE INVENTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

The embodiments described in greater detail here below and illustrated in the drawings specifically refer to automatic ring valves, i.e. automatic valves comprising a plurality of concentrically arranged, movable sealing rings. In other embodiments, not shown, a sealing plate made of one or more components constrained to one another to form a single movable sealing element can be provided instead of movable and concentrically arranged sealing rings.

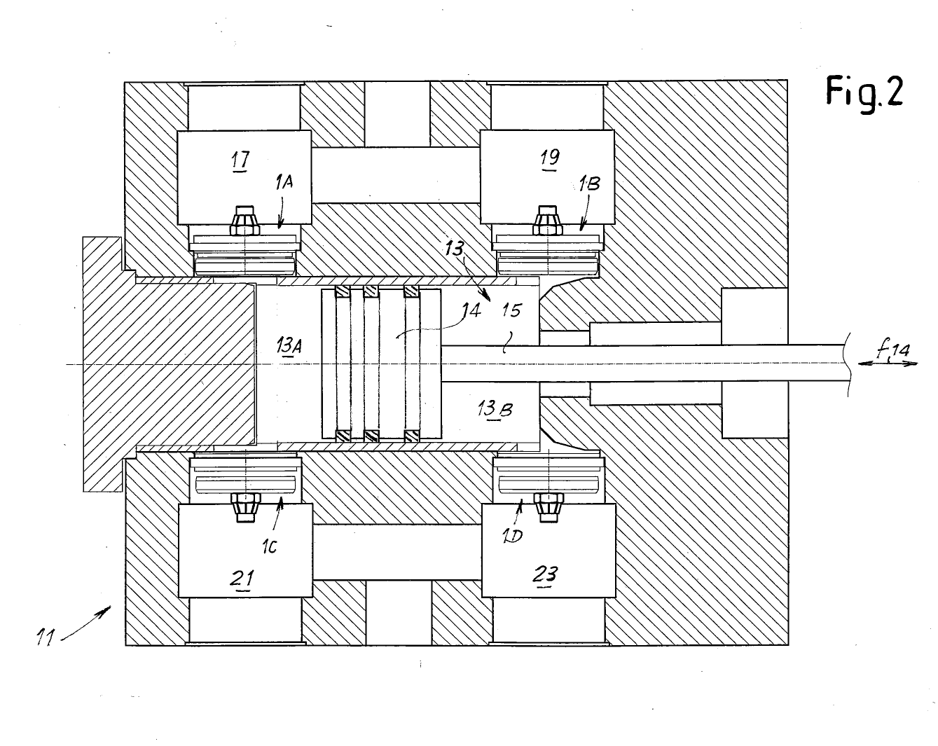

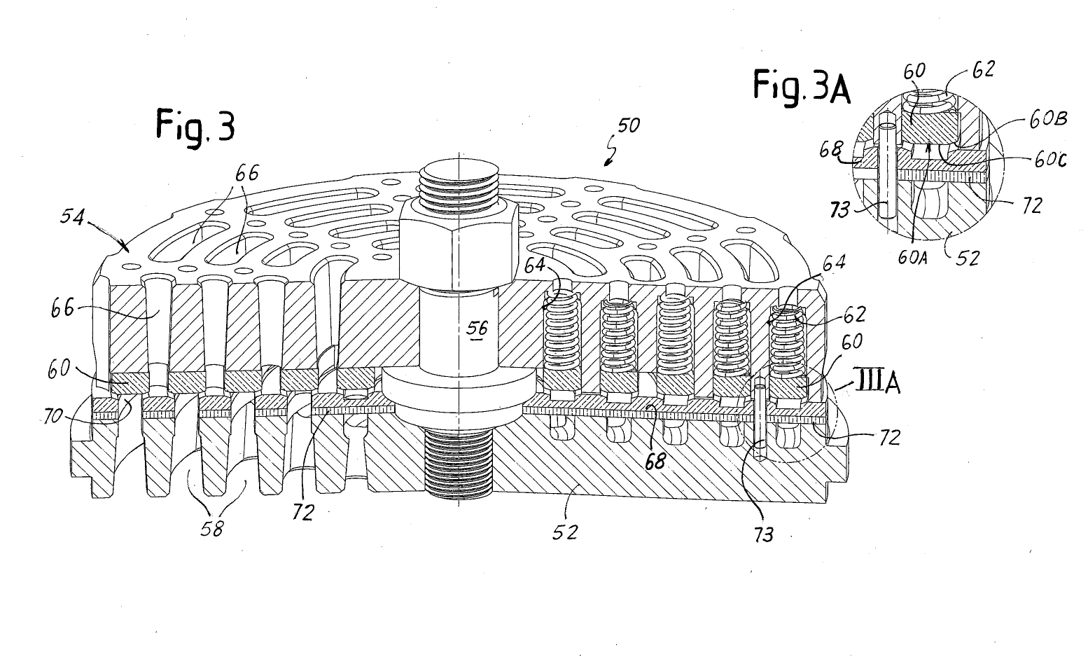

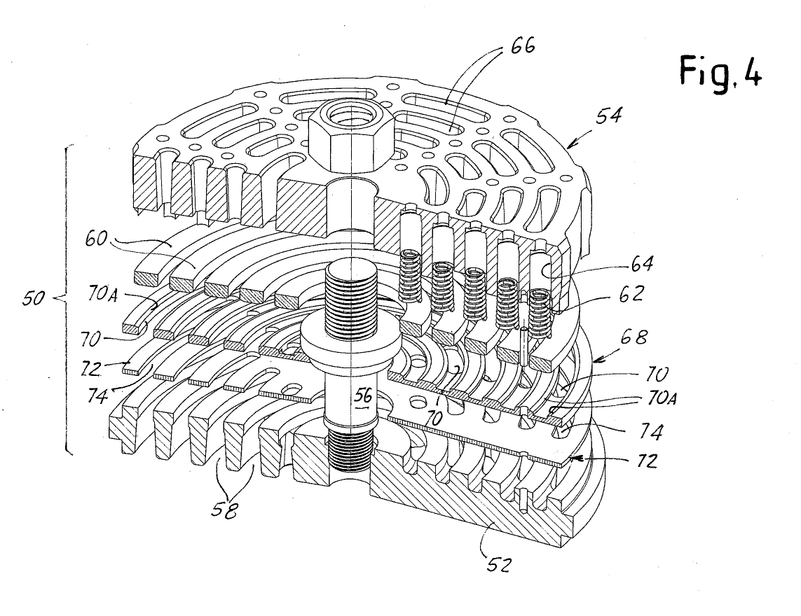

FIGS. 2 and 3 illustrate an exemplary embodiment of an automatic ring valve according to the subject matter disclosed herein. The automatic ring valve is globally designated 50. The valve 50 comprises a valve seat 52 and a valve guard 54. The valve seat 52 and the valve guard 54 are connected to one another by means of a screw arrangement 56. A space is left between the valve seat 52 and the valve guard 54, wherein movable sealing rings and a seat plate are arranged, as will be described in greater detail here below.

The valve seat 52 is provided with a set of first gas flow passages 58. In some embodiments the gas flow passages 58 have the shape of elongated curved holes or apertures. In some embodiments the gas flow passages 58 are arranged along concentrically disposed circumferences. In other embodiments the gas flow passages 58 can have a circular cross section, rather than being elongated. Each set of circumferentially arranged gas flow passages 58 is sealingly closed by said movable sealing rings.

In the embodiment illustrated in the drawings, the valve plate is comprised of a plurality of concentrically arranged sealing rings 60. In some embodiments the sealing rings 60 are one independent of the other, i.e. they are not constrained to one another. In other embodiments the sealing rings 60 can be connected to one another by constrain members such as to form a single unit with through apertures therein, allowing the gas to flow there through. In some embodiments, the sealing rings 60 can be connected to one another forming a single movable sealing element in the form of a valve plate of the valve plate will thus be provided with ring projections on one face of said valve plate, which will in tum be apertured, such as to provide a gaseous passage through the valve plate.

In the drawings each set of gas flow passages 58 arranged along the same circumference is closed by a respective one of said concentrically arranged sealing rings 60 by means of mutually co-acting sealing surfaces, as will be described in greater detail here below.

In some exemplary embodiments, as illustrated in the drawings, each sealing ring 60 is resiliently biased towards the valve seat 52 by a set of resilient members. The resilient members can comprise helical compression springs 62. Each compression spring 62 can be partly housed in a respective spring pocket 64 provided in the valve guard 54.

Other different resilient arrangements can be provided to bias the sealing rings 60 in the closing position towards the valve seat 52.

The valve guard 54 is provided with a set of second gas flow passages 66. Similarly to the first gas flow passages 58, also the second gas flow passages 66 can be arranged along concentrically extending circumferences and can be in the form of elongated curved apertures or holes. In other embodiments the second gas flow passages 66 can have a circular cross section rather than an elongated cross section. The first gas flow passages 58 and the second gas flow passages 66 are radially off-set such that when the sealing rings 60 are in the open position gas can flow through the valve 50.

In some embodiments each sealing ring 60 has a first planar sealing surface co-acting with the second planar sealing surface on the valve seat. In other embodiments, however, and as shown in the drawings, the sealing rings 60 have a sealing surface 60A which is at least partly non-planar. The sealing surface 60A can have a convex cross section. In some embodiments the sealing surface 60A is a curved convex sealing surface. In other embodiments, as shown in FIGS. 3A, 5, and 6, the sealing surface 60A can be comprised of two conical surface portions 60B and an intermediate planar surface 60C.

In other embodiments (see e.g. FIG. 7) the sealing surface 60A can be comprised of a central planar surface portion 60C and two lateral surface portions 60B, in the shape of convex toroidal surfaces.

According to the subject matter disclosed herein, the sealing rings 60 co-act with sealing surfaces which are formed on a seat plate 68 removably connected to the valve seat 52. The seat plate 68 is removable from the valve seat such that it can be replaced, e.g. if the seat plate breaks or is worn.

The seat plate 68 is provided with through passages or apertures 70. When the seat plate 68 is mounted on the valve plate 52 the through passages 70 are in alignment with the first gas flow passages 58 of the valve seat 52. In an embodiment, the through passages 70 have the same cross section as the gas flow passages 58. Thus, the through passages 70 are arranged according to a pattern matching the pattern of the first gas flow passages 58 of the valve seat 52, i.e. along concentrically arranged circumferential lines.

In some embodiments, the seat plate 68 has sealing surfaces 70A extending along the through passages 70 of the seat plate 68. Each set of circumferentially aligned apertures or through passages 70 are arranged between two concentrically extending sealing surfaces 70A. The sealing surfaces 70A are provided on circular projections formed on the seat plate 68.

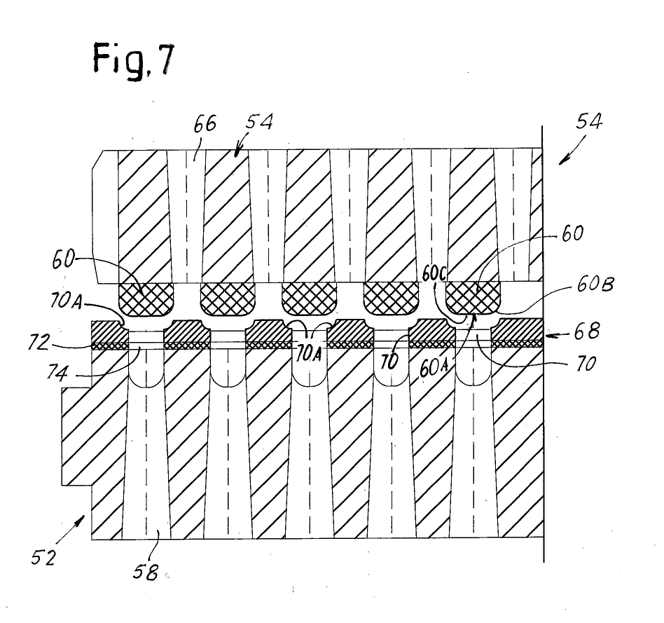

The shape of the sealing surfaces 70A is designed to match the sealing surface 60A of the sealing rings 60. One sealing ring 60 engages between two concentrically arranged sealing surfaces 70A, between which a set of apertures or through passages 70 is arranged. The sealing ring 60 can partly penetrate between oppositely arranged sealing surfaces 70A of the seat plate (see in particular FIGS. 5, 6 and 7). A wedging effect is thus obtained, which results in an enhanced sealing action.

In some embodiments the two sealing surfaces 70A arranged along a set of circumferentially arranged through passages or apertures 70 have conical surface portions (FIGS. 3, 5, 6) matching with the conical surfaces 60B of the corresponding sealing rings 60.

In other embodiments (FIG. 7) the sealing surfaces 70A have concave toroidal surface portions matching corresponding convex toroidal surface portions 60B of the sealing rings 60.

The sealing surfaces 60A and 70A can be designed such that each sealing surface 70A contacts the corresponding sealing surface 60A along a narrow annular contact surface A narrow contact area ensures high contact pressure and thus a high sealing efficiency. Conical surfaces or toroidal surfaces on both the sealing rings 60 and the seat plate 68 generate a self-centering effect of the sealing rings 60 with respect to the through passages or apertures 70 of the seat plate 68.

In some embodiments the sealing rings 60 are made of a composite material, such as a fiber-reinforced synthetic resin, more particularly a thermoplastic resin reinforced with carbon fibers or glass fibers.

In some embodiments, the seat plate 68 is made of the same material as the sealing rings 60. In other embodiments, the seat plate 68 can be made of a different material, such as a different fiber-reinforced synthetic resin, having substantially the same thermal expansion coefficient as the material sealing rings 60. By “substantially the same” thermal expansion coefficient, a coefficient is understood which differs from the thermal expansion coefficient of the material forming the sealing rings 60 such that the differential thermal expansion within the operating temperature ranges will not impair the sealing action. In some embodiments, the difference between the thermal expansion coefficient of the sealing rings and of the seat plate is 20% or less, and more particularly 15% or less or even more particularly 10% or less.

By using a composite material for both the sealing rings 60 and the seat plate 68, a reduction of the mass of the movable parts of the automatic ring valve is possible, while alleviating or removing the drawbacks of the known automatic ring valves, where the different thermal expansion coefficients of these two components causes gas leakages and consequent reduction of the efficiency of the machinery (e.g. a reciprocating compressor) where the valves are used.

Moreover, using an interchangeable or replaceable seat plate 68 makes maintenance of the valves easier. When the seat plate 68 is worn or broken, it can easily be replaced, without requiring disassembling of the valve from the machinery wherein the valve is mounted and avoiding machining of the valve seat.

In the exemplary embodiment illustrated in the drawings, the seat plate 68 is not in direct contact with the valve seat 52. Rather, between the seat plate 68 and the valve seat 52 a damper is arranged. In the embodiment shown, the damper comprises a shock absorber plate 72. The shock absorber plate 72 is apertured at 74. The apertures 74 are in alignment with the through passages 70 of the seat plate 68 and with the gas flow passages 58 of the valve seat and have, in an embodiment, the same cross-section as the latter. The shock absorber plate 72 is retained between the seat plate 68 and the surface of the valve seat 52 facing the sealing rings 60. One or more pins 73 can be provided for locking the seat plate 68 and the shock absorber plate 72 to the valve plate 52.

The shock absorber plate 72 dissipates or absorbs at least part of the kinetic energy of the sealing rings 60 during the closing stroke, such as to reduce the dynamic stress on the valve. The shock absorber plate 72 is made of a suitably energy-absorbing material. Suitable materials for the manufacturing of the shock absorber plate 72 are for example plastic or composite materials, such as thermoplastic resins reinforced with carbon fibers or glass fibers.

In an embodiment, the shock absorber plate 72 forms a sort of liner which separates the seat plate 68 from the valve seat 52, such that the seat plate 68 does not make direct contact with the planar surface of the valve seat 52 on which the shock absorber plate 72 is positioned. This ensures an efficient damping effect to reduce the mechanical shock on the valve when the sealing rings 60 close the first gas flow passages 58.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions.

What is claimed is:

1. An automatic valve, comprising:
a valve seat comprising first gas flow passages extending through said valve seat;
a valve guard comprising second gas flow passages extending through said valve guard;
at least one movable sealing element arranged between said valve guard and said valve seat; and
a removable seat plate removably connected to said valve seat, provided with apertures matching said first gas flow passages,
wherein said at least one movable sealing element is resiliently biased by resilient members against said removable seat plate to close said first gas flow passages, and wherein said removable seat plate and said at least one movable sealing element are made of non-metallic material.

2. The valve according to claim 1, wherein said removable seat plate and said at least one movable sealing element are made of a composite material.

3. The valve according to claim 2, wherein said composite material comprises a synthetic resin matrix containing reinforcing fibers or fillers.

4. The valve according to claim 3, wherein said synthetic resin matrix is made of a thermoplastic resin.

5. The valve according to claim 3, wherein said reinforcing fibers are selected from the group comprising: carbon fibers and glass fibers.

6. The valve according to claim 1, wherein said non-metallic material of said at least one movable sealing element and said non-metallic material of said removable seat plate have substantially the same thermal expansion coefficient.

7. The valve according to claim 1, wherein the non-metallic material of said at least one movable sealing element and said non-metallic material of said removable seat plate have respective thermal expansion coefficients of which differ from one another by 20% or less, within an operative temperature range of said valve.

8. The valve according to claim 1, wherein a damper is arranged between said removable seat plate and said valve seat.

9. The valve according to claim 1, wherein said at least one movable sealing element is provided with a plurality of first sealing surfaces, co-acting in sealing contact with second sealing surfaces on said removable seat plate which extend along said apertures in said removable seat plate.

10. The valve according to claim 9, wherein said plurality of first sealing surfaces and said plurality of second sealing surfaces are at least partly non-planar.

11. The valve according to claim 9, wherein pairs of said plurality of first sealing surfaces partly enter between corresponding pairs of said plurality of second sealing surfaces to close said first gas flow passages.

12. The valve according to claim 1, wherein said at least one movable sealing element is a sealing ring.

13. The valve according to claim 1, further comprising a plurality of concentrically arranged sealing rings.

14. The valve according to claim 1, wherein said at least one movable sealing element is a sealing plate.

15. The valve according to claim 14, wherein said sealing plate comprises ring projections co-acting with annular sealing surfaces on said seat plate.

16. The valve according to claim 1, wherein the non-metallic material of said at least one movable sealing element and said non-metallic material of said removable seat plate have respective thermal expansion coefficients of which differ from one another by 15% or less within an operative temperature range of said valve.

17. The valve according to claim 1, wherein the non-metallic material of said at least one movable sealing element and said non-metallic material of said removable seat plate have respective thermal expansion coefficients of which differ from one another by 10% or less within an operative temperature range of said valve.

18. The valve according to claim 2, wherein said non-metallic material of said at least one movable sealing element and said non-metallic material of said removable seat plate have substantially the same thermal expansion coefficient.

19. The valve according to claim 18, wherein said at least one movable sealing element is provided with a plurality of first sealing surfaces, co-acting in sealing contact with second sealing surfaces on said removable seat plate which extend along said apertures in said removable seat plate.

20. The valve according to claim 2, wherein said at least one movable sealing element is provided with a plurality of first sealing surfaces, co-acting in sealing contact with second sealing surfaces on said removable seat plate which extend along said apertures in said removable seat plate.
